(19) United States
(12) Patent Application Publication
(10) Pub. No.: US 2009/0321994 A1
(43) Pub. Date: Dec. 31, 2009

(54) INJECTOR FOR INJECTION MOULDING OF PLASTIC MATERIALS

(75) Inventors: Peter Dal Bo, Vittorio Veneto(Treviso) (IT); Lorenzo Scalon, Fiume Veneto (Pordenone) (IT)

Correspondence Address: HESLIN ROTHENBERG FARLEY & MESITI PC, 5 COLUMBIA CIRCLE, ALBANY, NY, 12203, US

(73) Assignee: Inglass S.p.A, San Polo di Piave (Treviso) (IT)

(21) Appl. No.: 12/304,897

(22) PCT Filed: Jun. 15, 2006
(86) PCT No.: PCT/IB2006/001673

§ 371 Date: Sep. 1, 2009

(51) Int. Cl. B29C 45/28; B29C 45/34

(52) U.S. Cl. 264/328.1; 425/546

(57) ABSTRACT

An injector for injection moulding of plastic materials incorporates a vacuum device for creating a suction pressure within the mould in an area corresponding to the injection point, prior to the injection of the plastic material.

### BACKGROUND OF THE INVENTION

The present invention relates in general to the moulding of plastic materials, and regards more in particular an injector for moulds for injection moulding of plastic materials.

### STATE OF THE PRIOR ART

Traditionally, injectors of this sort comprise a body having an axial passage for introduction of the fluid plastic material within a mould; a plug, which is axially mobile in the body for controlling said passage; and actuator means for governing the displacement of the plug between an advanced position for closing, and a retracted position for opening said passage, in which an injection point is provided.

An injector of this type is described and illustrated, for example, in the European patent No. EP-B-1277560.

In particular applications of multimaterial or multicolour moulding, typically in the moulding in a number of steps of transparent lenses or shields for the lights of motor vehicles within one and the same mould, there frequently exists the problem briefly described hereinafter with reference to FIGS. 5a and 5b of the annexed plate of drawings.

FIG. 5a is a schematic illustration of an example of a lens of the rear light of a motor vehicle, in which a main body 41, for example red in colour, is formed by injection into a mould using an injector, the trace of the injection point of which is designated by 43. The body 41 thus moulded has an empty area that is subsequently filled by a secondary body 42, for example of a different colour or colourless, formed by injection in the same mould using an injector, the trace of the injection point of which is designated by 44. FIG. 5b shows the lens without any optical defects, and hence in compliance with the required standards of quality.

However, with the above methodology the injection of the second material within the first material previously injected can at times generate burns, such as the one designated by 45 in FIG. 5a, deriving from the combustion of air imprisoned in the cavity of the mould and subjected to the extremely high moulding pressures. These burns are visible in the case of transparent articles, such as precisely the lenses of lights for motor vehicles, and involve the risk of a large number of moulded articles being rejected as they are not in compliance with the required standards of quality.

To prevent jeopardizing the quality of the moulded articles, it would hence be desirable to evacuate preliminarily the air contained in the cavity of the mould. In this way, beneficial effects could be obtained also as regards optimal filling of the cavity of the mould during injection, with an appreciable improvement of the aesthetic, and also structural, characteristics of the moulded articles.

From U.S. Pat. No. 5,961,898, a system is known for the application of a negative pressure in the area of the mould corresponding to the seat for the injector. This system enables removal of dust and foreign particles from said area prior to injection, but not evacuation of the air present in the cavity of the mould. Furthermore, the suction passage provided in the body of the mould entails constructional complications and burdensome additional machining operations on the mould itself.

### SUMMARY OF THE INVENTION

The object of the present invention is to solve the aforesaid technical problem, and more in particular to provide an injector that is intrinsically provided, in a relatively simple but functionally effective and reliable way, for evacuating the air present in the cavity of the mould to which it is operatively associated, without any need to modify the mould itself and in such a way as to guarantee an excellent aesthetic quality of the moulded items.

According to the present invention, said object is achieved thanks to the fact that an injector of the type defined above is characterized in that it is equipped with a vacuum device for applying a negative pressure within the mould, in an area corresponding to said injection point, prior to injection of the plastic material.

The vacuum device conveniently includes a suction pipe provided through the plug of the injector. In this case, the plug is tubular and the vacuum device comprises a stem, which is axially mobile through the cavity of the plug and is provided with an end open/close element. A source of negative pressure is connected to the cavity of the plug, and actuator means are provided for moving the stem axially between an inoperative position, in which the end open/close element closes the cavity of the plug, and an operative position, in which the open/close element opens the cavity of the plug for setting said source of negative pressure in communication with the mould.

Also provided are valve means for closing the communication between the source of negative pressure and the cavity of the plug in the inoperative position of the stem, and for opening said communication when the stem sets itself in the operative position.

Thanks to this arrangement, the injector according to the invention renders possible the application of the vacuum within the mould in an efficient way, without requiring any particular machining operations on the mould itself, thus ensuring an excellent quality of the items obtained following upon injection of the plastic material in the mould.

The use of the injector according to the invention is particularly—albeit not exclusively—advantageous in the cases where it is necessary to mould in a second step a certain amount of plastic material within a cavity enclosed by the material previously injected in a first step, which hence forms a frame around the cavity itself. In this case, the provision of traditional air vents is impossible, whilst the configuration of the injector according to the invention enables precisely evacuation of the air from the mould prior to the second injection step.

### BRIEF DESCRIPTION OF THE DRAWINGS

The invention will now be described in detail with reference to the annexed plate of drawings, which are provided purely by of way of non-limiting example and in which:

FIG. 1 is a schematic view in axial cross section of an injector for injection moulding of plastic materials according to the invention;

FIG. 2 shows a part of FIG. 1 at a larger scale;

FIGS. 3a and 3b show, at a larger scale, respectively in longitudinal section and in elevation, a detail of FIGS. 1 and 2;

FIG. 4 shows a variant of FIG. 2; and

FIGS. 5a and 5b represent schematically in elevation an article made of moulded plastic material, respectively according to the known art and according to the invention.

### DETAILED DESCRIPTION OF THE INVENTION

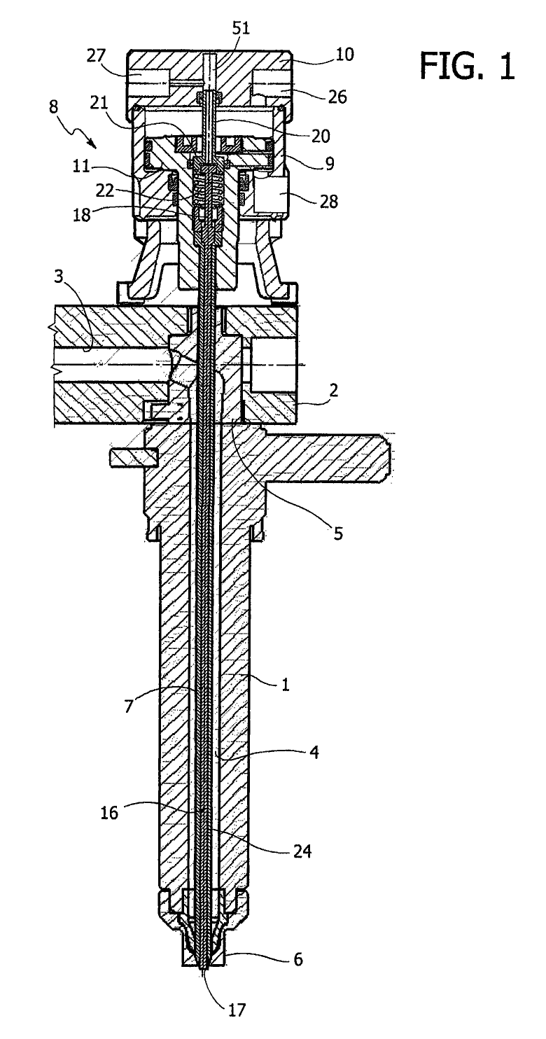

With reference initially to FIG. 1, an injector for injection moulding of plastic materials according to the invention basically comprises a tubular body 1, applied, in the case of the example illustrated, underneath a hot-chamber arm 2, equipped with a feed pipe 3 for supply of the fluid plastic material to be injected. The pipe 3 communicates with the cavity 4 of the tubular body 1 through a bushing 5, shaped so as to direct the flow of plastic material towards a terminal 6 of the injector, through which the plastic material is injected into the mould. In the case of the example illustrated, the terminal 6 comprises, in a way in itself known (for example, from the U.S. Pat. No. 6,832,909) a tip and a ring nut.

The passage through the terminal 6 is controlled in a conventional way by means of an axial plug 7, which is mobile along the cavity 4 of the body 1 and can be displaced, in the way clarified in what follows, between an advanced position of closing of the passage through the terminal 6 (represented in FIG. 1), and a retracted position of opening of the passage through said terminal 6.

The displacement of the plug 7 between the advanced position and the retracted one is controlled, also in a conventional way, via an actuator 8, constituted in the case of the example illustrated by a linear fluid actuator. In this case, the actuator 8 comprises a cylinder 9 closed hermetically by an end plate 10, and a piston 11 that can slide in a fluid-tight way in the cylinder 9 between the lowered position (illustrated in FIG. 1), corresponding to the advanced position of closing of the plug 7, and a raised position corresponding to the retracted condition of opening of said plug 7.

According to the fundamental characteristic of the invention, the injector incorporates a vacuum device for creating a suction pressure within the cavity of the mould to which it is associated in use, prior to injection of the plastic material into it.

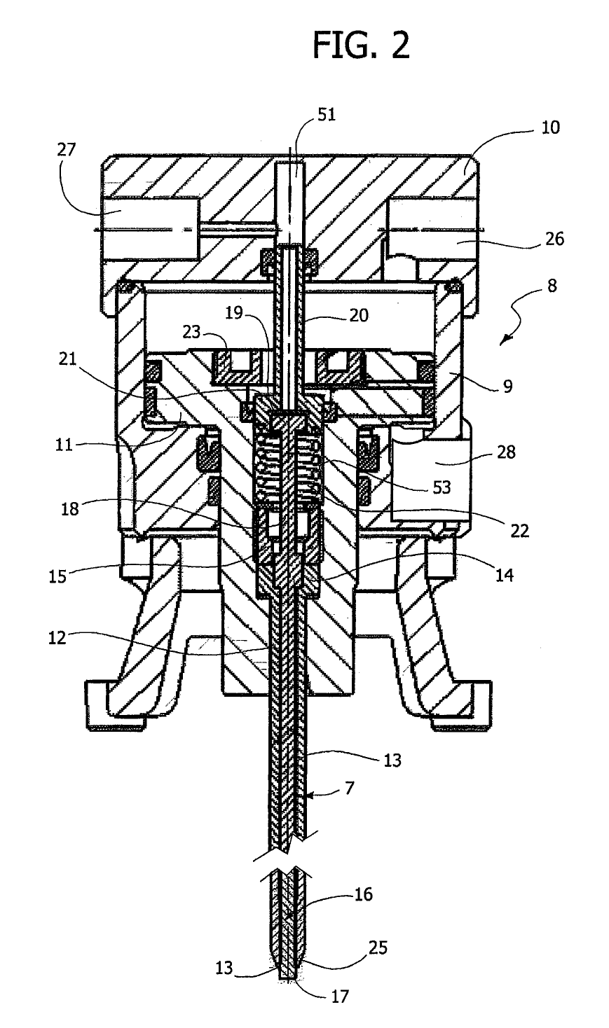

With reference now in greater detail to FIG. 2 (where, for reasons of simplicity of illustration, the tubular body 1 with the terminal 6 and the hot-chamber arm 2 have been omitted), the plug 7 is hollow and has a proximal end 12 and a tapered distal end 13, which constitutes the open/close element co-operating with the terminal 6.

The proximal end 12 extends through a central axial passage 53 of the piston 11, which has a generally tubular configuration and terminates with a widened head 14, blocked axially with respect to said piston 11 via an annular threaded grub screw 15.

Designated by 16 is a stem, which extends coaxially through the tubular plug 7 and can be displaced axially with respect to the latter with the modalities and for the purposes that will be described in what follows. The stem 16 has a distal end 17, which projects beyond the distal end 13 of the plug 7, and a proximal end 18, which extends through the passage 53 of the piston 11, as well as through the annular grub screw 15, and has a widened end head 19. The head 19 is fixed to an axial tubular extension 20, which extends through the cylinder 9 of the actuator 8 and the free end of which can slide in a fluid-tight way within a chamber 51 of the lid 10. On the opposite side, the tubular extension 20 has an annular flange 21, fixed within which is the head 19 of the distal end 18 of the stem 16 and which defines externally a surface of thrust 21 exposed to the actuation fluid of the actuator 8 in the top part of the cylinder 9.

Designated by 22 is a helical compression spring housed axially in the passage 53 of the piston 11 and set between the annular grub screw 15 and the tubular extension 20. The spring 22 tends to press the surface of thrust 21 axially against an arrest 23 constituted by an annular grub screw fixed within the passage 53 of the piston 11, coaxially with respect to the extension 20.

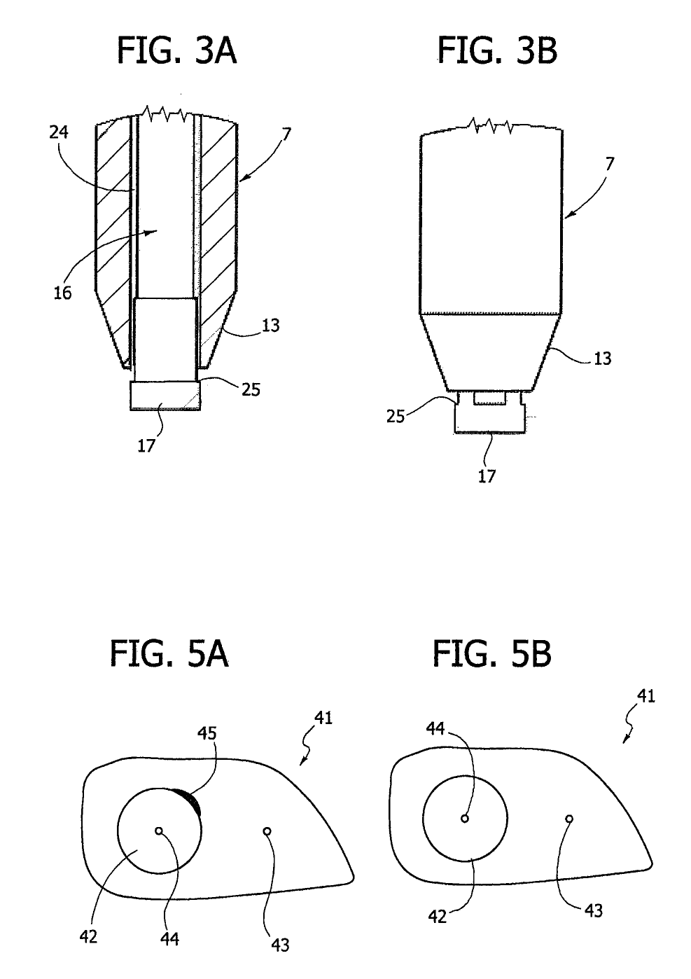

As is more clearly visible in FIG. 3a, defined between the tubular plug 7 and the stem 16 is a longitudinal annular gap 24, and the distal end 17 of the stem 16 has an annular flange 25 at the front facing the tapered distal end 13 of the plug 7.

The end plate 10 of the actuator 8 has an inlet 26, designed to connect a source of supply of a fluid under pressure with the top part of the cylinder 9 of the actuator 8, and an inlet 27, designed to be connected to a source of negative pressure. The inlet 27 is connected to the chamber 51, in which the extension 20, as has been said, can slide axially in a fluid-tight way.

A further inlet 28 is provided in the cylinder 9 for connecting the bottom area of the latter to the source of supply of the pressurized fluid.

Operation of the injector according to the invention referred to above is described in what follows.

When the piston 11 of the actuator 8 is located in the lowered position (represented in FIGS. 1 and 2), the plug 7 is kept in the advanced position of closing, in which the flow of the plastic material coming from the hot-chamber arm 3 towards the mould is prevented. In this condition, the spring 22 keeps the surface of thrust 21 of the extension 20 against the arrest 23 so that the stem 16 is kept in an inoperative retracted position, in which the open/close element defined by the annular flange 25 closes the gap 24 in an area corresponding to the distal end 13 of the plug 7.

This condition corresponds to the step that precedes injection of the plastic material within the mould to which the injector is associated, for example for the formation of the second component 42 of the lens 41, described previously with reference to FIG. 5b.

Starting from this condition, by increasing the pressure of the fluid within the cylinder 9 of the actuator 8 through the inlet 26 from an initial value designed to keep the plug 7 closed (for example, 8 bar) to a higher value (for example, 12 bar), the thrust applied on the surface 21 of the extension 20 causes advance of the latter, and hence of the stem 16, into the position represented in the drawings. Said advance produces, on the one hand, opening of the communication between the chamber 51 and the inlet 27, previously obstructed by the extension 20, as well as recession of the surface of thrust 21 from the arrest 23 against the action of the spring 22, and accordingly the recession of the open/close element 25 of the distal end 17 of the stem 16 from the tapered end 13 of the plug 7 (FIGS. 3a and 3b). In this way, the source of negative pressure connected to the inlet 27 is set in communication with the annular gap 24 and, through this, with the inside of the mould. The air present within the cavity of the mould is thus evacuated.

Once a pre-set interval of time has elapsed, which will depend upon the characteristics of the cavity of the mould and of the plastic material to be injected, the pressure of the fluid through the inlet 26 is brought back to the initial lower value, so that the stem 16 is brought back by the spring 22 into the starting position, in which the open/close element 25 closes at the front against the distal end 13 of the plug 7, obstructing the gap 24, and the surface of thrust 21 bears upon the arrest 23. Simultaneously, the extension 20 rises within the chamber 51 so as to re-close the communication between this and the inlet 27 connected to the source of suction pressure.

At the end of this step, it is possible to proceed to injection of the plastic material within the cavity of the mould by introducing fluid under pressure within the inlet 28 so as to displace the plug 7 into the retracted position of opening.

It will appear evident from the foregoing description that the injector according to the invention enables suction of the air from the cavity of the mould in an area corresponding to the same injection point through which the plastic material will subsequently be injected. In this way, optimal characteristics of moulding of the pieces are ensured, particularly (but not exclusively) of bi-component or pluri-component items, without any need to intervene on the structure of the mould, a fact that is particularly advantageous in the case of application of the injector according to the invention to existing moulds.

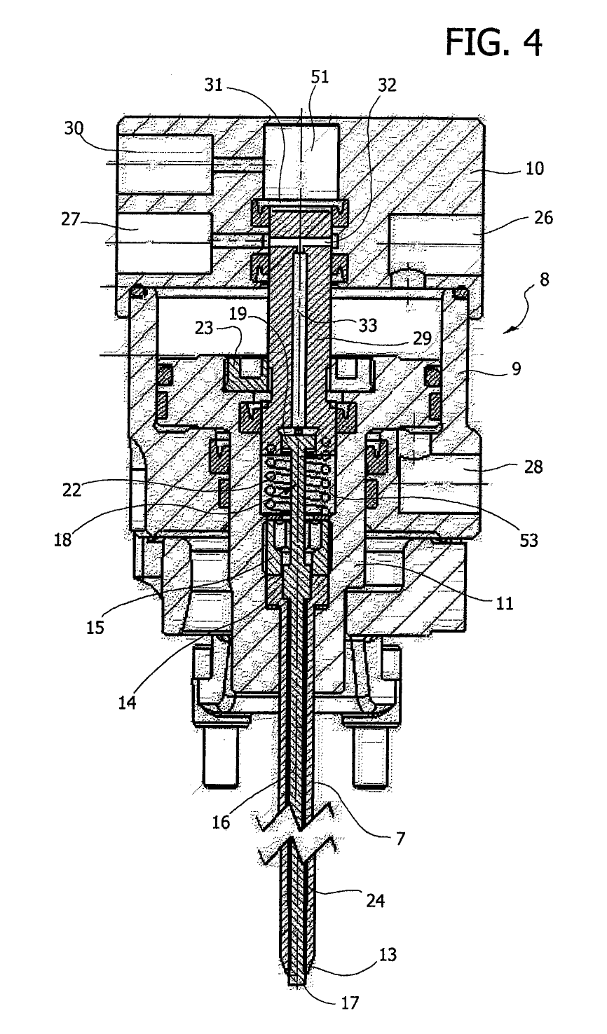

The variant represented in FIG. 4 is generally similar to the embodiment described previously, and only the differences will be described in detail, using the same reference numbers for parts that are identical or similar.

In said variant, the displacement of the stem 16 from the inoperative position to the operative position, represented in the drawing and in which the cavity of the mould is set in communication with the source of negative pressure connected to the inlet 27, is obtained, instead of by means of the pressurized fluid of the actuator 8, in an autonomous and independent way. For said purpose, the end plate 10 of the actuator 8 has a further inlet 30, designed to be connected to a source of pressurized fluid, communicating with the chamber 51. The extension of the stem 16, in this case designated by 29, is closed at its free end (i.e., on the side opposite to the head 19 of the distal end 18 of the stem 16) so as to define a terminal surface of thrust 31 exposed to the chamber 51. One or more radial passages 32 are formed at a distance from the surface of thrust 31 and communicate with the cavity of the extension 29, designated by 33.

In the inoperative position of the stem 16, in which the spring 22 keeps the extension 29 bearing axially upon the arrest 23, the radial passage or passages 32 are axially staggered with respect to the inlet 27 so that the communication between the gap 24 and the source of negative pressure is closed. To open said communication, in order to evacuate the air present in the cavity of the mould prior to injection of the plastic material, fluid under pressure is introduced within the inlet 30 and then into the top part of the chamber 51. The pressure acting on the surface of thrust 31 moves the extension 29 downwards until it positions the radial passage or passages 32 in a position axially corresponding to the inlet 27. At the same time, the stem 16 is moved into the operative position, so as to move the open/close element 25 of its distal end 17 away from the distal end 13 of the plug 7. In this way, the cavity of the mould is set in communication with the source of negative pressure through the gap 24, the passage 53 of the piston 11, the cavity 33 of the extension 29, and the radial passage or passages 32.

At the end of this step, supply of the pressurized fluid within the inlet 30 is interrupted, so that the spring 22 restores the initial inoperative condition of the stem 16 to enable displacement in opening of the plug 7 via the actuator 8, thus injecting the plastic material within the cavity of the mould.

Of course, the details of construction and the embodiments may vary widely with respect to what is described and illustrated herein, without thereby departing from the scope of the present invention, as defined in the ensuing claims.

1. An injector for injection moulding of plastic materials, including:
a body having an axial passage for the introduction of a fluid plastic material within a mould,
a plug, which is axially mobile in the body for controlling said passage,
actuator means for governing displacement of said plug between a position of closing, and a position of opening of said passage, in which an injection point is provided, and
a vacuum device for creating a suction pressure within the mould, in a position corresponding to said injection point, prior to injection of the plastic material.

2. The injector according to claim 1, wherein said vacuum device includes a suction pipe provided through said plug.

3. The injector according to claim 2, wherein said plug is hollow and said vacuum device comprises:
a stem which is axially mobile through the cavity of said plug and is provided with an end open/close element;
a source of negative pressure that can be connected to the cavity of said plug; and
actuator means for moving said stem axially between an inoperative position, in which said open/close element closes the cavity of the plug and an operative position, in which said open/close element opens the cavity of the plug for setting in communication said source of negative pressure with the mould.

4. The injector according to claim 3, further comprising valve means for closing the communication between said source of negative pressure and the cavity of said plug in the inoperative position of said stem, and for opening said communication when said stem sets itself in the operative position.

5. The injector according to claim 4, wherein said valve means include an open/close element formed by an extension of said stem, which can be displaced together with the latter.

6. The injector according to claim 5, wherein said extension is tubular.

7. The injector according to claim 5, wherein said actuator means for moving said stem include a piston operatively associated to said extension for displacing said stem axially from the inoperative position to the operative position via a fluid under pressure and against the action of elastic return means.

8. The injector according to claim 7, wherein said piston is formed integrally with said extension.

9. The injector according to claim 7, wherein said actuator means for controlling said plug between the position of closing and the position of opening includes a pressurized-fluid linear actuator, said piston using the same pressurized fluid as said linear actuator.

10. The injector according to claim 9, wherein said linear actuator includes a piston, said piston having an axial cavity, in which said piston, operatively associated to the extension of said stem, can slide in a fluid-tight way.

11. A method for injection moulding of plastic materials by means of an injector associated to a mould, comprising creating through said injector a negative pressure within the mould prior to injection of the plastic material.

12. The method according to claim 11, in which the plastic material is injected within the mould in an area corresponding to an injection point, said negative pressure applied in an area corresponding to said injection point through said injector.
